(19) United States
(12) Patent Application Publication
(10) Pub. No.: US 2024/0375813 A1
(43) Pub. Date: Nov. 14, 2024

(54) METHOD FOR ATTACHING A LABEL CARRIER TO AN INSULATING SHEATH OF AN ELECTRICALLY CONDUCTIVE WIRE

(71) Applicant: HARTING Electric Stiftung & Co. KG, Espelkamp (DE)

(72) Inventors: Luca BALTRUSCHAT, Minden (DE); Christof HERMONI, Rahden (DE)

(21) Appl. No.: 18/691,399

(22) PCT Filed: Oct. 10, 2022
(86) PCT No.: PCT/DE2022/100747

§ 371 Date: Mar. 12, 2024

(30) Foreign Application Priority Data
Oct. 19, 2021 (DE) 10 2021 127 006.5

(51) Int. Cl. B65C 7/00; B65C 9/18

(52) U.S. Cl. CPC B65C 7/00; B65C 9/1803

(57) ABSTRACT

Disclosed is a method for attaching a label carrier to an insulating sheath of an electrically conductive wire. According to the method a fastener tab having two wings made of resiliently expandable material is formed on the label holder, and a wire is introduced axially into a channel formed by the wings and is then held by friction between the wings.

The invention relates to a method for attaching a label carrier to an insulating sheath of an electrically conductive wire.

When a bundle of conductors consisting of a plurality of wires is connected to a plug connector, it is often expedient to attach to each of the individual wires a label carrier on which it is possible to indicate what function the relevant wire performs and how it is to be correctly connected.

Known label carriers, e.g. in the form of a plate which has two eyelets, are secured on a section of the wire by means of a cable tie, for example.

In the priority application relating to the present application, the German Patent and Trademark Office identified the following prior art: GB 2 539 549 A, DE 18 47 049 U, DE 655 749 A, DE 633 468 A and DE 30 23 232 A1.

It is the object of the invention to simplify the attachment of label carriers to the wires.

According to the invention, this object is achieved by virtue of the fact that a fastener tab having two wings made of an elastically expandable material is formed on the label carrier, and that the wire is inserted axially into a channel formed by the wings and is then held by friction between the wings.

Advantageous embodiments and developments of the invention are specified in the dependent claims.

The fastener tab including the wings can be formed in one piece with the label carrier, which can consist of plastic, for example.

The label carriers can themselves consist of a material that can be labeled. In another embodiment, the label carriers are configured in such a way that they allow the detachable or non-detachable attachment of a medium that can be labeled.

Exemplary embodiments are explained in greater detail below with reference to the drawing.

In the drawing:

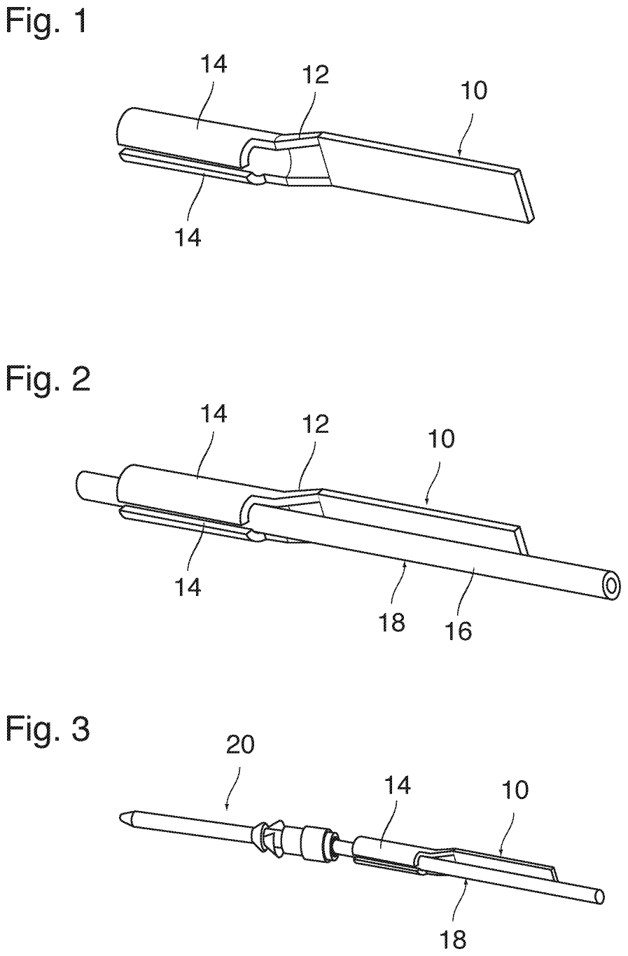

FIG. 1 shows a perspective view of a label carrier, which has a fastener tab having two wings;

FIG. 2 shows the label carrier according to FIG. 1 after fixing on an insulating sheath of an electrically conductive wire;

FIG. 3 shows the wire and the label carrier according to FIG. 2 together with a contact pin attached to the end of the wire;

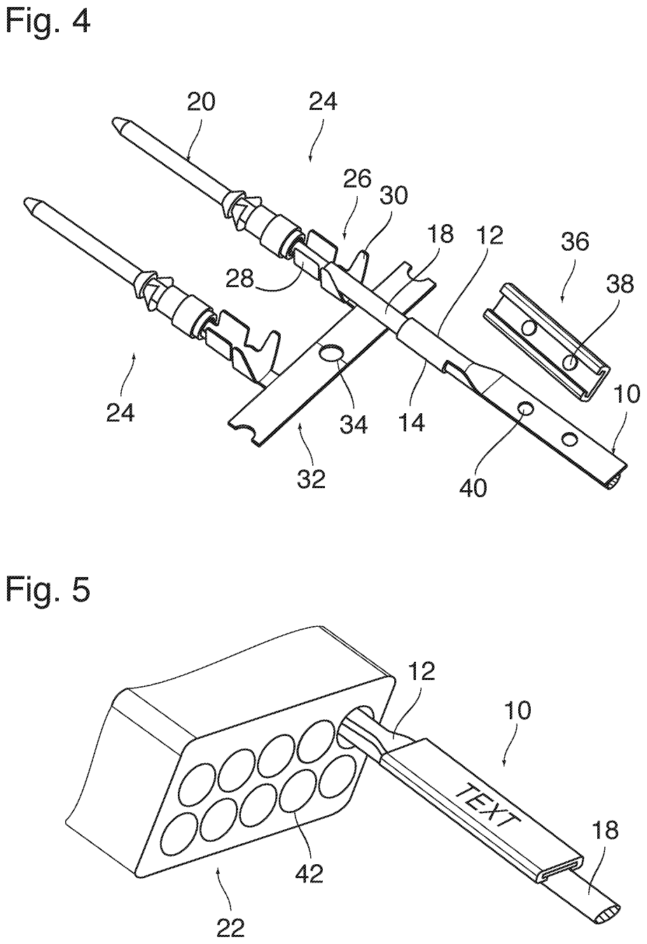

FIG. 4 shows the label carrier and the wire together with a contact belt, which forms a plurality of hybrid contacts;

FIG. 5 shows a view of a labeled wire, which is connected by means of the hybrid contact to a plug connector; and

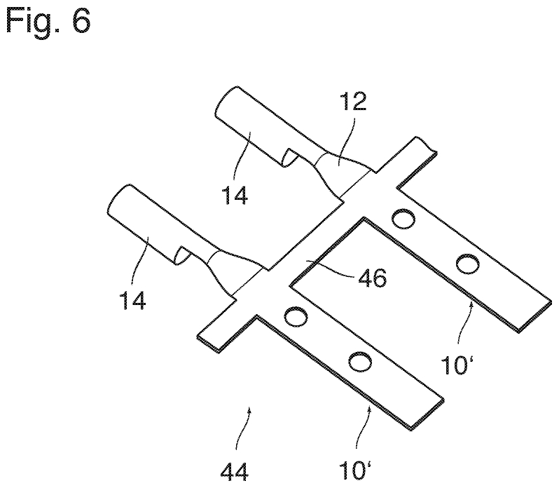

FIG. 6 shows an endless belt, which forms a series of label carriers according to another exemplary embodiment.

FIG. 1 shows a label carrier 10 in the form of a flat, elongate strip of plastic. Starting from one end of the label carrier 10 there is a fastener tab 12, the cross-sectional shape of which changes gradually from the flat profile of the label carrier 10 into two wings 14, which form a sleeve, optionally an internally conical sleeve, having a longitudinal slot. That section of the fastener tab 12 which carries the wings extends over a considerable length in the longitudinal direction of the label carrier and, overall, has the shape of a slotted tube into which an electrically conductive wire 18 (FIG. 2) can be inserted.

By means of the wings 14, the label carrier 10 can be fixed on an insulating sheath 16 of the wire 18, as shown in FIG. 2. For this purpose, the wire is inserted axially into the sleeve formed by the wings, wherein said sleeve is expanded elastically. In this way, the label carrier 10 is secured reliably and in a space-saving manner by friction on the wire 18.

The label carrier 10 and the fastener tab 12 with the wings 14 can be formed in one piece and can consist of a thermoplastic, for example.

FIG. 3 shows one end of the wire 18, to which is attached a contact pin 20 that serves to connect the conductor of the wire 18 electrically to a plug connector 22 (FIG. 5). The contact pin 20 is a turned part, which in this example is press-fitted directly onto an insulated end of the wire 18. The label carrier 10 is attached to the wire 18 in such a way that its wings 14 are at a certain distance from the end of the wire at which the contact pin 20 is located.

FIG. 4 shows a modified exemplary embodiment, in which the contact pin 20 is part of a so-called hybrid contact 24, which is connected to the insulated end of the wire 18 by a crimp contact 26.

The crimp contact 26 has two crimping wings 28, by means of which it is crimped onto the electric conductor of the wire 18. In addition, the crimp contact has two tension relief wings 30, which are crimped onto the insulating sheath of the wire.

The crimp contact 26 is connected via a predetermined breaking point to one section of a carrier belt 32, which is subdivided into sections of equal length by additional openings 34 for a transport member. Each of these sections carries a hybrid contact 24. This enables the hybrid contacts to be fed in rapid succession in the form of an endless contact belt to an automatic crimping machine (not shown), in which the crimping wings 28 and the tension relief wings 30 are closed. During or after this crimping process, the crimp contacts 26 are separated from the sections of the carrier belt 32.

In FIG. 4, the wire 18 has been inserted into the crimp contact 26 in such a way that the previously attached label carrier 10 is on the upper side of the wire. FIG. 4 also shows a covering profile 36, which can be slipped by means of its bent-around edges onto the label carrier 10. On the inside, the covering profile 36 has latching studs 38, which, after the covering profile has been slipped onto the label carrier 10. drop into latching holes 40 in said label carrier and thus fix the covering profile in the axial direction on the label carrier. In this embodiment, the label carrier 10 does not need to consist of a material that can be labeled. Instead, the covering profile 36 is labeled, making it possible to exchange the label easily when required.

In another embodiment, the label can be printed onto a narrow paper strip, which is then inserted into the covering profile 36 and slipped onto the label carrier 10 together with the covering profile. In this case, the covering profile 36 consists of a transparent material, enabling the label to be seen through the covering profile. In this case, the latching studs 38 can be omitted, thus enabling the paper strip to be inserted more easily.

FIG. 5 shows an end section of the plug connector 22, which has a plurality of contact openings 42 arranged at regular intervals in one end face. Each contact opening 42 accommodates a plug socket (not shown), into which one of the hybrid contacts 24 can be plugged. The end of the wire 18 on which this hybrid contact is secured, and the fastener tab 12 of the label carrier 10, then protrude from the contact opening. The width of the label carriers 10 is dimensioned in such a way that the label carriers are arranged side-by-side in a clearly visible manner when each of the contact openings 42 accommodates one wire. The flexibility of the wires and of the label carriers allows the upper layer of wires and label carriers to be bent upward somewhat, thus enabling the labels in the lower layer to be seen as well. To further improve visibility and to further reduce the space requirement, the label carriers 10 can be attached to the wires 18 in a manner offset with respect to one another in different longitudinal positions.

The flexibility of the label carrier 36 also enables this label carrier to be bent away somewhat from the wire 18 in order to slip on or pull off the covering profile 36.

FIG. 6 shows, as another exemplary embodiment, an endless belt 44 made of flexible plastic, which forms a plurality of label carriers 10′ arranged side-by-side in parallel, which each have a fastener tab 12 with wings 14 and are connected to one another by a connecting strip 46. Like the contact belt in FIG. 4, this endless belt 44 can be fed to an automatic machine by means of which the wires are inserted into the sleeves formed by the wings 14 and the bridges formed by the connecting strips 46 between the label carriers are then cut.

1. A method for attaching a label carrier to an insulating sheath of an electrically conductive wire, wherein a fastener tab having two wings made of an elastically expandable material is formed on the label carrier, and a wire is inserted axially into a channel formed by the wings and is then held by friction between the wings.

2. The method as claimed in claim 1, wherein the fastener tab is formed of a thermoplastic.

3. The method as claimed in claim 1, wherein a plurality of label carriers oriented parallel to one another are connected by at least one connecting strip to form an endless belt, and the endless belt is fed to a device in which the fastener tabs are attached to one wire each, and the connections between the individual label carriers are cut.

4. The endless belt for carrying out the method as claimed in claim 3, said belt comprising, a plurality of strip-shaped label carriers which are arranged parallel to one another, and connected to one another by a connecting strip and to form the endless belt, and wherein which each have at one end a fastener tab having two elastically expandable wings, which form a channel.

5. A contact arrangement having an electrically conductive wire, which has a contact pin at one end, and having a label carrier secured on the wire, wherein the label carrier has a fastener tab, which has elastically expandable wings, between which the wire is held by friction.

6. The contact arrangement as claimed in claim 5, having a plug connector which has a plurality of mutually adjacent contact openings, into each of which a contact pin connected to an electrically conductive wire can be inserted, wherein a label carrier is secured on each wire, and the width of the label carriers, which extend in the longitudinal direction of the wires, is not greater than the spacing between the contact openings.

7. The method as claimed in claim 2, wherein a plurality of label carriers oriented parallel to one another are connected by at least one connecting strip to form an endless belt, and the endless belt is fed to a device in which the fastener tabs are attached to one wire each, and the connections between the individual label carriers are cut.

8. The endless belt for carrying out the method as claimed in claim 7, said belt comprising a plurality of strip-shaped label carriers which are arranged parallel to one another, and connected to one another by a connecting strip to form the endless belt, and wherein which each have at one end a fastener tab having two elastically expandable wings, which form a channel.
